(19) United States
(12) Patent Application Publication
(10) Pub. No.: US 2011/0250311 A1
(43) Pub. Date: Oct. 13, 2011

(54) FORMULATIONS AND METHODS FOR MAINTAINING NORMAL HORMONE LEVELS

(76) Inventor: Harunobo Amagase, Phoenix, AZ (US)

(21) Appl. No.: 13/131,144

(22) PCT Filed: Feb. 5, 2009
(86) PCT No.: PCT/US09/33223

§ 371 Date: May 25, 2011

(30) Foreign Application Priority Data
Dec. 10, 2008 (US) 61121432

(51) Int. Cl. A23L 1/30

(52) U.S. Cl. 426/2; 426/648

(57) ABSTRACT

The invention provides methods for maintaining normal levels of catecholamines, glucocorticoids, adrenal steroids, and their related hormones in a human subject by administering Lycium plants or Lycium plant extract preparations, preferably goji juice. The invention also provides a food or dietary supplement formulation, which contains Lycium plants or Lycium plant extract preparations.

### CROSS-REFERENCE TO RELATED APPLICATIONS

This application claims priority to and benefit of U.S. Provisional Patent Application Ser. No. 61/121,432, filed on Dec. 10, 2008, which is incorporated herein by reference in its entirety.

### FIELD OF THE INVENTION

The invention relates generally to formulations and methods for maintaining normal levels of catecholamines, glucocorticoids, adrenal steroids, and their related hormones in mammals.

### BACKGROUND OF THE INVENTION

Excess levels of catecholamines, glucocorticoids, adrenal steroids, and their related hormones in the body are strong risk factors for various diseases and abnormal conditions. Maintaining these catecholamines, glucocorticoids, adrenal steroids, and their related hormones at normal levels is essential for maintaining good health. If one loses control of these catecholamines, glucocorticoids, adrenal steroids, and their related hormones, various symptoms occur, such as headache, stress, mood change, high blood pressure, palpitations, tachycardia, arrhythmia, anxiety, tremors, acute pulmonary edema, high cholesterol, visceral fat accumulation, obesity, metabolic syndromes, increased risk of various cancers, and others. Catecholamines, glucocorticoids, adrenal steroids, and their related hormones also influence gastrointestinal functions by constricting the gastrointestinal tract and suppressing blood supply. Abnormal increases in catecholamines, glucocorticoids, adrenal steroids, and their related hormones can cause elevated glucose levels which result from insulin resistance, diabetes, and an increase in catabolism of glycogen to glucose in the liver. Most importantly, catecholamines, glucocorticoids, adrenal steroids, and their related hormones suppress the immune system.

Methods for maintaining normal glucocorticoid and adrenal steroid levels vary from psychotherapy to drug treatments. However, these treatments take time to have positive effects, and many long-term drug treatments have adverse side effects.

Because many people are adverse to psychotherapy and long term drug treatments, the number of patients with excess levels of catecholamines, glucocorticoid and adrenal steroids, and their related hormones is rising sharply. Accordingly, a need exists for compositions and methods of maintaining normal catecholamines, glucocorticoid and adrenal steroid levels in subjects, which avoid psychotherapy and long-term drug treatments.

### SUMMARY OF THE INVENTION

Here, the inventors demonstrate versatile formulations and methods for maintaining normal levels of catecholamines, glucocorticoids, adrenal steroids, and their related hormones in mammals.

Accordingly, the present invention provides a method for maintaining normal levels of catecholamine, glucocorticoids, adrenal steroids, and their related hormones in a body, the method comprising administering a composition comprising Lycium plants (known as goji, gouqizi, Fructus lycii or wolfberry) or Lycium plant extract preparations to the subject, whereby the subject's normal hormone levels are maintained. In an alternate preferred embodiment, the composition comprises goji juice.

In another embodiment, the invention provides a method of maintaining normal catecholamine, glucocorticoids, adrenal steroids, and their related hormones in the body, the method comprising administering a composition comprising Lycium plants or Lycium plant extract preparations, whereby the subject's catecholamine, glucocorticoids, adrenal steroids, and their related hormones are maintained in normal levels. In an alternate preferred embodiment, the composition comprises goji juice.

In yet another embodiment, the invention provides a food and/or a formulation combined with another ingredient comprising an effective amount of Lycium plants or Lycium plant preparations and at least one other food and/or drug ingredient. In an alternate preferred embodiment, the composition comprises goji juice.

The invention also encompasses the use of Lycium plants or Lycium plant preparations, preferably goji juice, for the manufacture of food and/or a formulation combined with another ingredient to maintain normal glucocorticoid, adrenal steroids, and their related hormone levels in a subject ingesting the food formulation. Lycium plants or Lycium plant preparations, preferably goji juice, packaged and presented for use in the maintaining normal glucocorticoid and adrenal steroids levels are also within the invention.

Other objects, features and advantages of the present invention will become apparent after review of the specification, claims and drawings.

### BRIEF DESCRIPTION OF THE DRAWINGS

FIG. 1. Changes of catecholamine, cortisol and dihydroepiandrosterone (DHEA) levels 30 days after beginning goji or placebo control consumption. Stress-related hormones are significantly increased in the placebo group, but their increase was inhibited by consuming GoChi. Values indicate the percent of change in hormone levels between levels prior to consuming GoChi and levels after 30 days of consumption.

### DETAILED DESCRIPTION OF THE INVENTION

### I. In General

Before the present materials and methods are described, it is understood that this invention is not limited to the particular methodology, protocols, materials, and reagents described, as these may vary. It is also to be understood that the terminology used herein is for the purpose of describing particular embodiments only, and is not intended to limit the scope of the present invention, which will be limited only by any later-filed nonprovisional applications.

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, and “having” can be used interchangeably.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are now described. All publications and patents specifically mentioned herein are incorporated by reference for all purposes including describing and disclosing the chemicals, instruments, statistical analysis and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

### II. The Invention

Herein, the inventors provide formulations and methods for maintaining normal levels of catecholamines, glucocorticoids, adrenal steroids, and their related hormones in mammals.

The Lycium plants in this invention are the plants belonging to the family of solanaceous defoliated shrubbery, such as, Lycium barbarum and Lycium chinensis. The most suitable plant for this invention is Lycium barbarum (known as goji, gouqizi, fructus lycii, or wolfberry). The preferred portion for this invention is the fruit of this plant. Leaf, root, stem or any other parts of this plant may also be utilized for this invention. These materials can be processed as juice or dried by processing and/or extraction methods commonly known in the art.

In addition, the materials derived from the cell culture of the plants can also be utilized as materials for this invention. The juice or extract of the Lycium plants in this invention is preferably the preparation made from plant materials prepared or extracted from water or alcohol. The Lycium plants for the preparation or extraction can be squeezed or crushed with or without a heating to effect extraction efficiency, as is routinely understood in the art. It is also possible to crush and homogenize the plants to make the juice after separating skin, seeds and other parts. The extract prepared for dietary intake can be utilized as is, in concentrated fluid or powder form after concentration under vacuum or lyophilization.

The administrative dosage of the preparation effective to maintain normal catecholamines, glucocorticoids, adrenal steroids, and their related hormones are varied by the age, body weight, or body condition of the subject. It is recommended that adults orally consume 0.001 oz (0.03 ml) through 33 oz (990 ml) of a liquid preparation of Lycium plants or extracted Lycium plants daily. The more feasible and preferred dosage ranges approximately from 1 oz (30 ml) to 8 oz (240 ml) of the preparations per day for an adult human.

The following examples describing materials and methodology are offered for illustrative purposes only, and are not intended to limit the scope of the present invention.

### III. EXAMPLES

Example 1. Randomized, Double-Blind, Placebo-Controlled Human Clinical Study.

This example describes a randomized, double-blind, placebo-controlled human clinical study which examined the efficacy of orally consumed goji berry, Lycium barbarum, as a standardized juice (GoChi®) in healthy adults. Levels of catecholamines, such as epinephrine and norepinephrine, cortisol, a glucocorticoid, and DHEA, an adrenal steroid, were measured after consuming 120 ml (4 oz) of GoChi per day for a period of 30 days. GoChi was consumed 120 ml (4 oz) in the morning. Data were statistically analyzed for changes between day 1 and day 30.

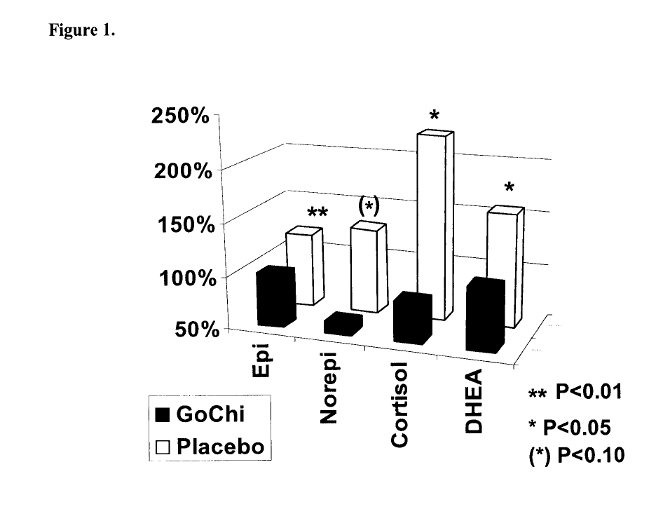

All catecholamine, cortisol and DHEA levels measured in GoChi group (N=20) on day 30 remained at normal levels. In contrast, the placebo group (N=19) showed statistically significant increases in epinephrine, cortisol, and DHEA levels as shown in FIG. 1. Additionally, the placebo group showed a tendency toward increases in norepinephrine levels, also shown in FIG. 1.

These results clearly indicate that daily consumption of GoChi for 30 days maintains normal catecholamine, glucocorticoid and adrenal steroid hormone levels.

Other embodiments and uses of the invention will be apparent to those skilled in the art from consideration of the specification and practice of the invention disclosed herein. All references cited herein for any reason, including all journal citations and U.S./foreign patents and patent applications, are specifically and entirely incorporated herein by reference. It is understood that the invention is not confined to the specific reagents, formulations, reaction conditions, etc., herein illustrated and described, but embraces such modified forms thereof as come within the scope of the following claims.

1. A method of maintaining normal levels of catecholamines, glucocorticoids, adrenal steroids, and their related hormones in a subject, comprising administering a composition comprising Lycium plants or Lycium plant extract preparations to the subject, whereby the subject's catecholamines, glucocorticoids, adrenal steroids, and their related hormones are maintained at normal levels.

2. A method of maintaining normal levels of catecholamines, glucocorticoids, adrenal steroids, and their related hormones in a subject, comprising administering a composition comprising goji juice to the subject, whereby the subject's catecholamines, glucocorticoids, adrenal steroids, and their related hormones are maintained at normal levels.

3. A food or dietary supplement formulation comprising an effective amount of Lycium plants or Lycium plant preparations to maintain normal levels of catecholamines, glucocorticoids, adrenal steroids, and their related hormones in a subject ingesting said food or dietary supplement formulation and at least one other food or dietary supplement ingredient.

4.-8. (canceled)
